(19) United States
(12) Patent Application Publication
(10) Pub. No.: US 2003/0047071 A1
(43) Pub. Date: Mar. 13, 2003

(54) CO2 rejection from natural gas

(76) Inventors: William B. Dolan, Yardley, PA (US); Michael J. Mitariten, Pittstown, NJ (US)

Correspondence Address: Stuart D. Frenkel, Law Office of Stuart D. Frenkel, P.C., 3975 University Dr., Suite 330, Fairfax, VA, 22030, US

(21) Appl. No.: 09/945,870

(22) Filed: Sep. 4, 2001

(51) Int. Cl. B01D 53/02

(52) U.S. Cl. 95/96; 95/139

(57) ABSTRACT

An improved pressure swing adsorption process is provided for removing or separating a gas from a mixture of gases. The PSA process comprises selectively adsorbing a gas from the mixture to form a product gas having a reduced concentration of the selectively adsorbed gas and a low pressure purge stream containing a higher level of the selectively adsorbed gas than contained in the mixture. During regeneration of the adsorbent a co-current recycle stream is provided which has a pressure less than the product stream, but greater than the purge stream for recycle to feed so as to minimize loss of the product gas to purge. The PSA process is particularly useful for removing carbon dioxide from coal bed methane.

### FIELD OF THE INVENTION

This invention relates to the purification of methane, and, more particularly, to the removal of carbon dioxide from methane-containing gas streams using a novel pressure swing adsorption (PSA) process.

### BACKGROUND OF THE INVENTION

Recently, the availability of new energy sources for U.S. consumption whether for business or residential uses, has become a subject of public debate. Energy deregulation, energy shortages, price and production control by OPEC and increased domestic energy consumption have yielded state-wide rolling energy blackouts, as well as significantly higher prices for both oil products (gasoline) and natural gas. Government authorization for making new energy sources available has become dependent on a balancing of obtaining energy such as by off-shore sea drilling, or drilling in pristine wilderness vs. environmental concerns. It is clear that a lasting viable domestic economy will depend on finding additional sources of energy or utilizing existing sources better.

One particular source of energy which has only recently been exploited is coal bed methane (CBM). CBM is a growing area of methane gas supply, with growth from near 0 to about 6% of U.S. production (1 TCF/year) in the past decade. In the production of CBM, shallow wells are drilled into coal beds and the methane is slowly desorbed from the coal and produced at the surface at low pressure. Drilling costs are low, the wells are generally low risk and the well life is quite long. These advantages are somewhat balanced against a low flow rate per well. The wells are drilled with as little as forty acre spacing. Major areas of development include the San Juan basin (near the four-corners) and Powder River basin in Wyoming. The Appalachian basin is also of interest, although for smaller flow rates. The gathering system for CBM is quite extensive. In general, the wells operate with a Roots type blower drawing the gas from the coal bed near atmospheric pressure and discharging it into a low pressure gathering system at 15 psig. Well capacity ranges from about 0.1-0.4 MMSCFD with 0.15 MMSCFD being typical. In the large Powder River basin, wells are tied together with a gas flow rate of 5 MMSCFD being reached and the gas then compressed to about 100 psig in a screw compressor. Multiple screw compressor stations can be tied together and the gas compressed to 800-1,000 psig at flows of 15-40 MMSCFD.

Coal bed methane is quite different from natural gas. CBM contains little C₂+ hydrocarbon content and, accordingly, liquids recovery is not justified. CBM does not contain hydrogen sulfide and is only occasionally contaminated with nitrogen. Often, however, CBM is contaminated with carbon dioxide. In CBM, CO₂ contamination levels are often 5% or more, but are typically less than 15%. Product requirements, however, typically include a CO₂ concentration of less than 2 mole percent.

It is well-known to remove acid gases such as hydrogen sulfide and carbon dioxide from natural gas streams using an amine system wherein the acid gases are scrubbed from the feed with an aqueous amine solvent and solvent subsequently stripped of the carbon dioxide or other acid gases with steam. These systems are widely used in industry with over 600 large units positioned in natural gas service in the U.S. The amine solvent suppliers compete vigorously and the amines used range from DEA to specialty formulations allowing smaller equipment and operating costs while incurring a higher solvent cost. These systems are well accepted although they are not very easy to operate. Keeping the amine solvent clean can be an issue. In processing CBM, one challenge would be the lack of hydrogen sulfide, since hydrogen sulfide can help passivate the carbon steel metallurgy. Accordingly, a higher level of stainless steel with its attendant higher cost can be required. The low pressure of CBM also raises the possibility of introducing oxygen. Oxygen, unfortunately, reacts with amine solvents and can form corrosive salts.

Another disadvantage to using aqueous amines is that the feed to an aqueous amine system is wet and the aqueous amine produces a water saturated methane product. Accordingly, glycol dehydration would be required on the product stream after the carbon dioxide has been removed adding operational and capital costs to the purification process.

For smaller volume applications where gas flows are less than five or ten million cubic feet per day, considerable attention has been given to the development of pressure swing adsorption (PSA) processes. This technology is based on the tendency of solids to attract or bind gaseous molecules to their surface, and for some solids to attract certain gases more strongly than other gases. Typically, the higher the pressure of the gas, the more is adsorbed on the surface of the solid. A curve representing this relationship at a constant temperature (temperature also has an effect on the amount of gas adsorbed) is called an isotherm. Though adsorption is not well understood, it is thought that the adsorbed gas forms a partial or complete layer only one or at most a few molecules thick on the surface of the solid. This layer can be thought of as being a liquid state of the gas. Sometimes a gas is not desorbed as readily as it is adsorbed, so that the desorption isotherm will show hysteresis in comparison to the adsorption isotherm. Gas separations using pressure swing adsorption processes are based on the selective adsorption on the solid, or adsorbent, of some gases over others as pressures are increased, thereby concentrating the gas that is less strongly adsorbed. When the pressure is decreased the adsorbed gas is desorbed, thereby regenerating the solid for successive cycles of adsorption and desorption. Solids used in PSA processes are typically those that have very large surface areas, such as activated carbon, silica gel, alumina or molecular sieves (zeolites), which have the added advantage of being able to screen out gases having molecular diameters larger than the pores in the zeolite. It is believed that the PSA system for removal of CO₂ can be operated at a lower cost and is a simpler operation relative to the aqueous amine separation system. One particular cost advantage of the PSA system is the elimination of the glycol dehydrator.

In general, first applications of PSA processes were performed to achieve the objective of removing smaller quantities of adsorbable components from essentially non-adsorbable gases. Examples of such processes are the removal of water from air, also called heatless drying, or the removal of smaller quantities of impurities from hydrogen. Later this technology was extended to bulk separations such as the recovery of pure hydrogen from a stream containing 30 to 90 mole percent of hydrogen and other readily adsorbable components like carbon monoxide or dioxide, or, for example, the recovery of oxygen from air by selectively adsorbing nitrogen onto molecular sieves. Numerous patents further describe PSA process for separating carbon dioxide from methane or other gases. They have in common the use of one of the adsorbents described above that adsorb carbon dioxide, preferentially over methane. One of the earlier patents in this area is U.S. Pat. No. 3,751,878, which describes a PSA system using a zeolite molecular sieve that selectively adsorbs CO₂ from a low quality natural gas stream operating at a pressure of 1000 psia, and a temperature of 300° F. The system uses carbon dioxide as a purge to remove some adsorbed methane from the zeolite and to purge methane from the void space in the column. U.S. Pat. No. 4,077,779, describes the use of a carbon molecular sieve that adsorbs CO₂ selectively over hydrogen or methane. After the adsorption step, a high pressure purge with CO₂ is followed by pressure reduction and desorption of CO₂ followed by a rinse at an intermediate pressure with an extraneous gas such as air. The column is then subjected to vacuum to remove the extraneous gas and any remaining CO₂.

U.S. Pat. No. 4,770,676, describes a process combining a temperature swing adsorption (TSA) process with a PSA process for the recovery of methane from landfill gas. The TSA process removes water and minor impurities from the gas, which then goes to the PSA system, which is similar to that described in U.S. Pat. No. 4,077,779 above, except the external rinse step has been eliminated. CO₂ from the PSA section is heated and used to regenerate the TSA section. U.S. Pat. No. 4,857,083, claims an improvement over U.S. Pat. No. 4,077,779 by eliminating the external rinse step and using an internal rinse of secondary product gas (CO₂) during blowdown, and adding a vacuum for regeneration. The preferred type of adsorbent is activated carbon, but can be a zeolite such as 5A, molecular sieve carbons, silica gel, activated alumina or other adsorbents selective of carbon dioxide and gaseous hydrocarbons other than methane.

U.S. Pat. No. 4,915,711, describes a PSA process that uses adsorbents from essentially the same list as above, and produces two high purity products by flushing the product (methane) from the column with the secondary product (carbon dioxide) at low pressure, and regenerating the adsorbent using a vacuum of approximately 1 to 4 psia. The process includes an optional step of pressure equalization between columns during blowdown. U.S. Pat. No. 5,026,406 is a continuation in part of U.S. Pat. No. 4,915,711 with minor modifications of the process.

U.S. Pat. No. 5,938,819 discloses removing CO₂ from landfill gas, coal bed methane and coal mine gob gas, sewage gas or low quality natural gas in a modified PSA process using a clinoptilolite adsorbent. The adsorbent has such a strong attraction to CO₂ that little desorption occurs even at very low pressure. There is such an extreme hysteresis between the adsorption and desorption isotherms, regeneration of the adsorbent is achieved by exposure to a stream of dry air.

PSA processes are typically carried out in a multi-bed systems as illustrated in U.S. Pat. No. 3,430418 to Wagner, which describes a system having at least four beds. As is generally known and described in this patent, the PSA process is commonly performed in a cycle of a processing sequence that includes in each bed: (1) higher pressure adsorption with release of product effluent from the product end of the bed; (2) co-current depressurization to immediate pressure with release of void space gas from the product end thereof; (3) counter-current depressurization to a lower pressure; (4) purge; and (5) pressurization. The void space gas released during the co-current depressurization step is commonly employed for pressure equalization purposes and to provide purge gas to a bed at its lower desorption pressure. Variations on the processing scheme are known typically for the purpose of reducing the cycle time achieved between pressurization, depressurization and repressurization. The faster the beds perform steps 1 to 5 to complete a cycle, the smaller the beds can be when used to handle a given hourly feed gas flow. If two steps are performed simultaneously, the number of beds can be reduced or the speed of cycling increased, reducing costs. See, for example, U.S. Pat. No. 3,738,087 to McCombs.

U.S. Pat. No. 4,589,888 to Hiscock, et. al. discloses that reduced cycle times are achieved by an advantageous combination of specific simultaneous processing steps. The gas released upon co-current depressurization from higher adsorption pressure is employed simultaneously for pressure equalization and purge purposes. Co-current depressurization is also performed at an intermediate pressure level, while countercurrent depressurization is simultaneously performed at the opposite end of the bed being depressurized.

Although pressure swing separation adsorption has been used to separate a wide variety of gases, it is believed that there is no commercially practiced PSA process for the separation of CO₂ from coal bed methane. Unfortunately, traditional PSA systems for removing carbon dioxide from natural gas would be unattractive due to the fact that a substantial portion of the feed methane would be lost when the system is regenerated. That is, co-adsorbed methane or methane left within the void spaces of the adsorbent during the blow down step and subsequent purge step with methane results is substantial losses of methane. This loss of product gas from the void space during depressurization is not only a problem during purification of methane, but is a typical problem during separation of any gaseous stream by PSA processing. Thus, chemical absorption such as by aqueous amines for CO₂ removal has an advantage over a PSA system in that the absorption process has little loss of the non-acid gas component (methane). However, in cases where a use for the tail gas of a PSA system can be found, a dry adsorption system will generally be preferred so as to eliminate the capital and operating costs of chemical absorption including the costs associated with dehydration. Moreover, a chemical adsorption system such as an aqueous amine system is not free of losses and the use of a re-boiler requires a substantial fuel consumption.

Existing membrane technologies for removing CO₂ from natural gas are also known. However, membrane systems can behave poorly in the presence of heavier hydrocarbon species often found in natural gas.

It is the primary objective of this invention to provide a PSA process for removing carbon dioxide from methane which minimizes losses of methane.

Another object of the present invention is to provide a pressure swing adsorption process for the removal of carbon dioxide from coal bed methane.

A further object of the present invention is to separate carbon dioxide from methane with an improved PSA process which is competitive with amine-solvent based separation systems.

Still another object of this invention is to provide a PSA process for gas separation wherein energy costs are reduced and product loss minimized.

### SUMMARY OF THE INVENTION

This invention provides a novel PSA system to remove carbon dioxide from methane, including natural gas, coal seam gas and any other methane-containing hydrocarbon feed gas streams. As previously stated, prior PSA systems for removing CO₂ from natural gas are unattractive due to the fact that a substantial portion of the feed methane is typically lost when the PSA adsorbent is regenerated. In accordance with this invention, an integrated process is provided to minimize the methane losses and to make a PSA process competitive with historical amine solvent-based systems for removing polar gases from hydrocarbon feed streams. In this invention, the feed gas is introduced to a bed of adsorbent selective for carbon dioxide over methane and the CO₂ adsorbed and removed from the feed stream while operating on a PSA cycle. Subsequent to the adsorption of the carbon dioxide, one or more pressure equalization steps (depressurizing co-current to the feed) are conducted in which the methane is removed from the adsorber vessel in the step following adsorption and transferred into one or more other vessels undergoing purge or repressurization steps. Such pressure equalization and purge steps in a PSA process are well understood by those of ordinary skill in the art. In traditional PSA processing, at the end of such co-current depressurization steps, the adsorber vessel is depressurized in a direction counter-current to the feed stream and the impurity, in the case of the present invention, CO₂, is partially removed. The removal of the impurity is further conducted by purging the bed, typically with a light gas component, commonly the desired product gas. In the present invention, rather than following the traditional co-current depressurization steps of equalization or provide purge with a counter-current blow down step, an intermediate step or steps of co-current depressurization is used in which the co-current depressurization stream substantially containing the desirable methane is removed at intermediate pressure and recycled back to the feed step of the PSA process.

The co-current recycle or vent recycle to feed in the PSA process of the present invention allows the PSA system to further treat methane gas that would otherwise be lost during the blow down step and substantially increases the overall methane recovery rate offered by the system. At the end of the co-current depressurization step, the traditional blow down followed by purge steps and subsequent repressurization can be conducted. It can also be desirable to conduct additional co-current depressurization steps (such as equalizations) after the co-current depressurization recycle step. Further it may be advantageous to feed the recycle gas as a separate step either after adsorption (if the recycle is higher in CO₂ concentration) or before adsorption (if the recycle is lower in CO₂ concentration)

### BRIEF DESCRIPTION OF THE DRAWINGS

FIG. 1 is a schematic of a prior art PSA process illustrating the recycle to feed of the low pressure waste stream.

FIG. 2 represents the integrated PSA process of this invention for removing carbon dioxide from a hydrocarbon gas stream.

### DETAILED DESCRIPTION OF THE INVENTION

In general, the present invention is directed to the removal of carbon dioxide from methane-containing hydrocarbon streams by an improved pressure swing adsorption process. The methane-containing feed can comprise natural gas, coal seam gas (coal bed methane-CBM) as well as any other feed streams which contain methane, hydrocarbons and carbon dioxide. While the process of the present invention is particularly useful for removing carbon dioxide from coal bed methane, the PSA process of this invention is not intended to be limited to this particular feed. The treatment of coal seam gas or coal bed methane is particularly interesting since this gas is different from natural gas in that the CBM contains only small amounts of C₂+ hydrocarbons, rendering liquids recovery not practical, does not contain hydrogen sulfide and is only occasionally contaminated with nitrogen. CBM, however, is often contaminated with carbon dioxide in amounts of less than about 15 mole percent. Methane product requirements are typically at a carbon dioxide concentration of less 2 mole percent. In the PSA process of this invention, a methane-containing gas having CO₂ levels greater than 15 mole percent can be treated, but there may be some higher loss of methane from the PSA system.

The PSA process of the present invention for adsorbing carbon dioxide from methane-containing streams contains process steps not found in typical PSA processes. Thus, the PSA for removing carbon dioxide includes a co-current intermediate pressure dump or vent step and recycle of the vent stream to the feed of the PSA unit. Recycle steps in many PSA systems are often referred to as rinse steps and consist of recycling waste gas back to the feed. However, compression requirements for recycling waste gas to feed pressure are significantly higher than the recycle of this invention as the typical waste stream is available at about 7 psia, while the co-current dump or vent gas stream is available at a higher pressure of at least about 15 psia. Those skilled in the art will recognize that compression requirements scale with the inverse of the suction pressure. Accordingly, significant compressor energy costs can be saved by recycling the intermediate co-current vent gas stream, not to mention the fact that the methane present in the void space of the adsorbent can be collected and recycled to feed, thus greatly minimizing methane losses. Further, the vent flow will be substantially higher in methane concentration than the waste gas, hence minimizing the amount of CO₂ that would have to be adsorbed.

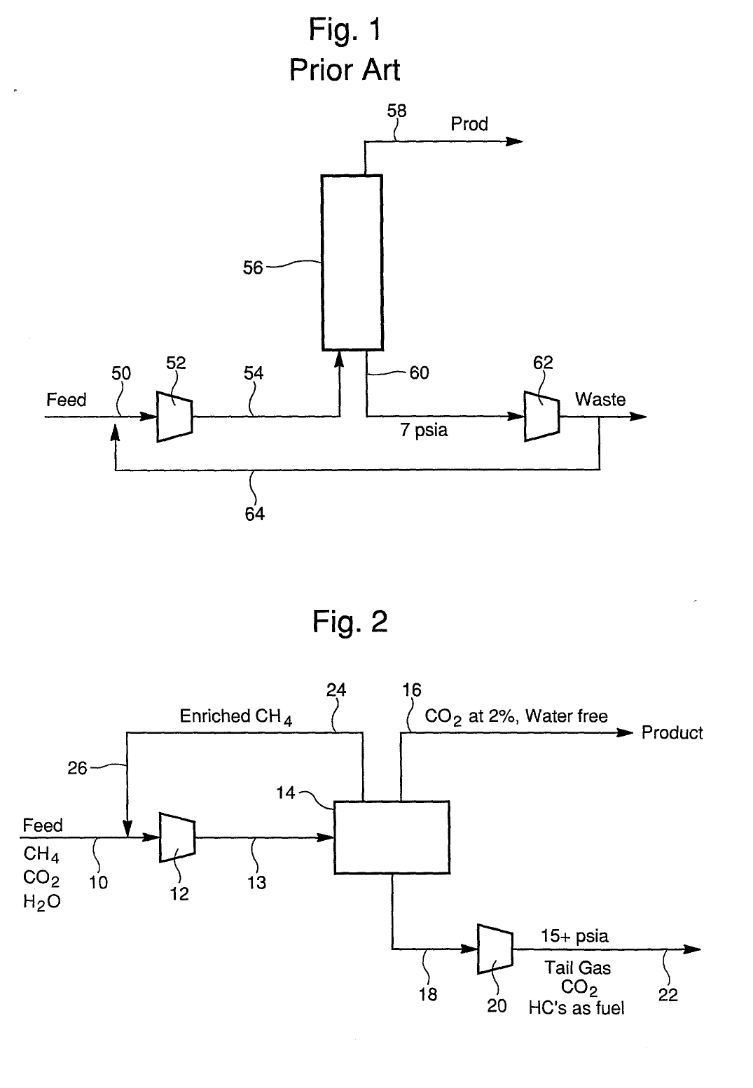

The traditional PSA process for separation of gases wherein at least one gas is selectively removed from a mixture by a solid adsorbent and the adsorbent regenerated by pressure swing is shown in FIG. 1. As schematically illustrated therein, a feed stream 50 containing a mixture of gases is compressed in compressor 52 to adsorption pressure and directed to the PSA adsorbent bed 56 via line 54. Product gas, typically that which is not adsorbed by the adsorbent leaves the downstream portion of the bed via line 58. During the depressurization cycle, the adsorbed gas is removed from the feed portion of the bed at low pressure via line 60. Typically this waste gas at low pressure contains the adsorbed gas and a significant portion of product gas which has been removed from the void spaces of the adsorbent bed. To recover this product gas, the low pressure stream must be pressurized to feed pressure such as by compressor 62 and a portion of the waste gas recycled to feed via line 64. The compression of the very low pressure purge or waste gas from the adsorbent bed is very energy intensive as this waste gas must be pressurized from the low pressure typically below 10 psia to operational pressure which can typically be over 100 psia. In the present invention, it is not the low pressure waste gas which is recycled, but a co-current intermediate pressure stream which is taken from the downstream end of the adsorbent bed and which has a significantly higher pressure than the waste stream leaving the bed. Accordingly, substantial savings in energy costs are achieved. Moreover, since the waste gas is very energy intensive to pressurize to operational pressure, this waste gas is often dumped or used for fuel. In this instance, substantial portions of the product gas are lost. The present invention seeks to minimize the product loss.

In its broadest aspect, this invention is directed to an improved PSA process for use in any type of gas separation in which an intermediate pressure co-current vent stream is recycled to feed. The vent stream has a lower pressure than the product gas stream, but is at a higher pressure than the purge or waste gas stream. Recycle power requirements are vastly lowered relative to waste gas recycle, and product gas loss is minimized. In this broad aspect of the invention, the feed to the process can include hydrogen, carbon monoxide, carbon dioxide, nitrogen, inert gases, and hydrocarbons. The improved PSA process can be used to separate hydrogen from adsorbable compounds such as carbon monoxide, carbon dioxide, nitrogen, and hydrocarbons or the process can be used to separate methane from less adsorbable compounds including carbon dioxide, sulfur oxides, hydrogen sulfide, heavier hydrocarbons, and mixtures thereof. By the term “hydrocarbons”, it is meant hydrocarbons having from 1 to 8 carbon atoms per molecule including alkanes, alkenes, cycloalkenes, and aromatic hydrocarbons such as benzene.

An overview of the preferred process of this invention can be described by referring to FIG. 2. As shown, a methane-containing gas stream 10 can optionally be compressed to operational adsorption pressure by compressor 12 prior to entering the PSA process 14. Compressor 12 may be needed if the methane stream is coal bed methane which is typically gathered at low pressure. Stream 10 will typically contain over 2 mol. % carbon dioxide. The PSA process 14 of this invention is in actuality composed of one or a series of multiple beds operating in parallel during adsorption, desorption, and intermediate pressurization/depressurization (equalization) steps. Each bed typically contains an adsorbent which selectively adsorbs CO₂ from the methane-containing gas stream 10. CO₂-selective adsorbents such as previously described for the PSA process of the present invention are known and readily available on the commercial market. A methane product stream 16 leaves PSA 14 having a reduced carbon dioxide content to approximately 2 mol. % or less. Preferably, the adsorbent also removes water from gas stream 10 so that the methane product stream 16 is essentially water-free. The waste gas of PSA 14 is a CO₂-rich stream 18. Stream 18 leaves the adsorbent of PSA process 14 during depressurization/desorption of the adsorbent bed at a low pressure of 5 to 10 psia, and can then be compressed via compressor 20 to form a waste or tail gas stream 22.

Important to the process of the present invention, gas stream 24 is produced during co-current desorption of the adsorbent bed in PSA process 14. Stream 24 has a pressure intermediate the pressure of product stream 16 and the pressure of stream 18. Stream 24 is recycled back and combined with the feed 10 via stream 26. The combined stream 13 can then be compressed by compressor 12, if needed. If needed, gas stream 24 can be compressed prior to combining with feed 10 if the feed 10 is at a pressure higher than the co-current vent stream 24.

More specific process parameters are now given with respect to the application of the preferred process of this invention. Again, referring to FIG. 2, PSA 14 is used to adsorb carbon dioxide from a methane-containing gas stream such as coal bed methane. Operation of PSA 14 involves the following steps: adsorption, equalization, co-current depressurization to compression, provide purge, fuel, countercurrent depressurization, purge, equalization and pressurization. These steps are well-known to those of ordinary skill in this art. Reference is again made to U.S. Pat. Nos. 3,430,418; 3,738,087 and 4,589,888 for a discussion of these internal steps of a PSA process. The CO₂ adsorption process, PSA 14, begins with the CO₂ adsorption step in which pressurized gas stream 10 as line 13 is fed to a bed containing a carbon dioxide selective adsorbent. Feed 10 is typically at a pressure of about 15 psia which represents the methane pressure from the well.

This well head pressure is increased via compressor 12 to an operational pressure of about 150-800 psia. Reference number 14 is meant to include the PSA stages described immediately above. Carbon dioxide adsorption yields a product stream 16 rich in methane, reduced in carbon dioxide and at a slightly lower operational pressure as feed 13. After the adsorption step, the bed is co-currently depressurized in a series of steps referred to in the art as equalizations. After the adsorbent bed has completed 1 to 4 equalizations, the adsorbent bed can be further co-currently depressurized. The gas leaving the bed during the co-current depressurization, depicted as stream 24 can be used as either fuel, provide purge, recycled back to feed or any combination thereof. Stream 24 will have a pressure of 10 to 100 psia, preferably 15 to 50 psia. At this point in the PSA cycle, it may be advantageous to do additional equalization steps. Subsequently, the bed is counter-currently depressurized, and then purged with gas from the earlier provide purge step. The adsorbent bed is pressurized with gas from earlier equalizations, and finally the bed is pressurized with product gas or alternatively feed gas. These steps are routine, and except for recycling the co-current intermediate pressure dump stream 24 to feed stream 10 are known in the art. This latter step is unique and important for overall process efficiency including improvement in operational costs. By using a co-current dump stream for recycle instead of the typical waste stream recycle, operational energy costs (compression costs) are saved as the dump stream 24 is compressed to feed pressure from a higher pressure than the waste stream. Subsequent to recycling the dump stream 24, a further depressurization/equalization step to about 20 psia can be performed to recover methane values from void space gas before a final purge to waste gas at low pressure, e.g. 7 psia. Without the further depressurization/equalization, valuable methane gas would be purged to waste 18/22. This intermediate pressure vent recycle can be used to improve energy costs and minimize product loss in any PSA used for gas separation. Copending, commonly assigned U.S. Ser. No. 09/699,664, filed Oct. 30, 2000 describes such process for nitrogen separations from methane.

Waste gas stream 18 can be pressurized to 15+psia via compressor 20 to stream 22 which can be used as fuel to operate primary compressor 12. This waste stream, primarily CO₂ will contain some hydrocarbons which have heat value that can be used.

As previously stated, it is believed that the advantages of the intermediate pressure vent recycle would be present in any PSA system regardless of the gas separation taking place. Furthermore, it is believed that the advantages of the intermediate pressure recycle are not compromised by the particular adsorbent utilized. In the preferred process of the present invention for removing carbon dioxide from a methane-containing gas stream, it is believed that any known CO₂-selective adsorbent is useful. As previously described, these include activated carbon, alumina, silica and zeolite molecular sieves. There are many patents describing particular zeolites and modifications thereof, including cation exchange, which are useful carbon dioxide-selective adsorbents such as for removing carbon dioxide from hydrocarbon streams including methane. A particularly preferred adsorbent for use in removing carbon dioxide from methane-containing gas streams, and, in particular, coal bed methane, is a silica gel adsorbent marketed under the name PCS™, sold by Engelhard Corporation, Iselin, N.J. This particular adsorbent, contains a higher micropore volume than similar silica gel adsorbents. Thus, the micropore volume (cm³/g) as % intrusion volume is at least 15%, measured by the AutoPore IV 9500, (Hg Porosimetry) and TriStar 3000 (N₂ Porosimetry), both from Micrometrics, Narcross, Ga. This percent of micropore volume relative to the total pore volume is believed higher than known commercial silica gel adsorbents. The PCS™ adsorbent also has a higher uptake of carbon dioxide as shown in CO₂ isotherms compared with other silica gel adsorbents. It is believed that the micropore volume provides the improved CO₂ uptake of this particular silica adsorbent. Table 1 sets forth the properties of PCS™. Table 2 is a comparison of silica adsorbent PCS™ with a commercial silica adsorbent, Sorbead R, from Engelhard Corporation.

TABLE 1

| | | PCS ™ |
|---|---|---|
| Regeneration Temp | ° C. | 170 |
| BET surface area | m²/g | 756 |
| Micropores | % | 15 |
| Pore Volume | cm³/g | 0.48 |
| Average Pore Diameter | nm | 2.5 |
| Water Adsorption at 25° | | |
| C. and | | |
| 10% r.H. | % | 7.2 |
| 80% r.H. | % | 42.9 |
| XFA | | |
| SiO₂ | % | >99 |
| Al₂O₃ | % | <0.5 |
| Na | % | <0.05 |
| Packed Density | kg/1 | 0.64 |

TABLE 2

| | Sorbead R | PCS ™ |
|---|---|---|
| Pore Volume (1000-20000A) as % | 2.47% | 25.27% |
| Intrusion Volume¹ | | |
| Micropore Volume as % of | 4.90% | 22.96% |
| Intrusion Volume² | | |

¹Hg Porosimetry AutoPore IV 9500, Micromeritics, Norcross, GA
²N2 Porosimetry TriStar 3000, Micromeritics, Norcross, GA

### EXAMPLE

Pilot Plant testing was completed on two adsorbents, PCS™ and a commercial silica gel adsorbent, with a cycle utilizing a vent recycle as in this invention. A 1″ ID by 2 feet long bed was loaded with adsorbent. The bed was fed a feed gas of 30% CO₂, balance methane at 150 psia for a period of 2 minutes. After the adsorption step was completed, an equalization step was performed over a period of 30 seconds. From the equalization pressure to 44 psia, a vent step was executed for a period of 90 seconds. The bed was next depressurized from the feed end from the pressure of 44 psia to a pressure of 7 psia. At 7 psia the bed was purged with 0.95 standard liters of product gas for a period of 90 seconds. After the purge step, the bed was repressurized first with the equalization gas and then subsequently with product gas. The results of pilot plant testing was as follows:

| Adsorbent | Com. | PCS ™ |
|---|---|---|
| Feed/Cycle | 9.5 standard | 12.5 standard |
| | liters/cycle | liters/cycle |
| Purity Feed | 30% CO₂/Bal CH₄ | 30% CO₂/Bal CH₄ |
| Purity Product | 7% CO₂/93% CH₄ | 4.5% CO₂/Bal CH₄ |
| Single Pass | 62.25% | 76.9% |
| Recovery | | |
| Overall Recovery | 82% | 89.8% |
| with vent recycle | | |

Results show that the PCS™ material performs substantially better than the commercial silica gel adsorbent and would be preferred material for this process.

Once given the above disclosure, many other features, modifications, and improvements will become apparent to the skilled artisan. Such other features, modifications, and improvements are, therefore, considered to be a part of this invention, the scope of which is to be determined by the following claims.

We claim:

1. A pressure swing adsorption (PSA) process for the separation of a single gas from a mixture of gases which comprises:
a) passing a feed stream comprising said mixture in contact with an adsorbent which is selective for said single gas in a PSA unit so as to preferentially adsorb said single gas and produce a product depleted in said single gas and a low pressure purge stream having a higher concentration of said single gas than said mixture;
b) co-currently depressurizing said PSA unit to form a recycle stream having a lower concentration of said single gas than said purge stream, said recycle stream having a pressure less than said product stream, but greater than said purge stream; and
c) recycling said recycle stream to said feed stream.

2. The process of claim 1, wherein said purge stream is at a pressure of less than 10 psia and said recycle stream is at a pressure of 10 to 100 psia.

3. The process of claim 2, wherein said recycle stream is at a pressure of from 15 to 50 psia.

4. The process of claim 1, wherein said single gas is carbon dioxide.

5. The process of claim 4, wherein said mixture includes methane.

6. The process of claim 1, wherein said mixture of gases includes methane.

7. The method of claim 6, wherein said mixture comprises natural gas.

8. The process of claim 6, wherein said mixture comprises coal bed methane.

9. The process of claim 4, wherein said mixture comprises coal bed methane.

10. The process of claim 9, wherein said product stream comprises no more than 2 mol. % carbon dioxide.

11. The process of claim 7, wherein said single gas is carbon dioxide.

12. A pressure swing adsorption (PSA) process for the separation of carbon dioxide from a mixture of the same with methane which comprises:
a) passing a feed stream comprising said mixture in contact with a carbon dioxide-selective adsorbent in a PSA unit so as to preferentially adsorb carbon dioxide and produce a methane-rich product stream and a low pressure purge stream having a higher molar concentration of carbon dioxide than said mixture;
b) co-currently depressurizing said PSA unit to form a recycle stream rich in methane, said recycle stream having a pressure less than said methane-rich product stream, but greater than said purge stream; and
c) recycling said recycle stream to said feed stream.

13. The process of claim 12, wherein said mixture comprises natural gas.

14. The process of claim 12, wherein said mixture comprises coal bed methane.

15. The process of claim 12, wherein said mixture is at a pressure of 60 to 100 psia when in contact with said carbon dioxide selective adsorbent.

16. The process of claim 12, wherein said purge stream is at a pressure of less than 10 psia.

17. The process of claim 16, wherein said recycle stream is at a pressure of from 10 to 100 psia.

18. The process of claim 17, wherein said recycle stream is at a pressure of 15 to 50 psia.

19. The process of claim 12, wherein said methane-rich product stream contains no more than 2 mol. % carbon dioxide.

20. The process of claim 12, wherein said carbon dioxide selective adsorbent is silica gel.

21. The process of claim 20, wherein said silica adsorbent has a percentage of micropore volume of at least 15% relative to intrusion pore volume of said adsorbent as measured by the AutoPore IV 9500 and TriStar 3000, manufactured by Micrometrics, Norcross, Ga.

22. The process of claim 21, wherein said mixture comprises coal bed methane.
